(19) United States
(12) Patent Application Publication
(10) Pub. No.: US 2026/0076856 A1
(43) Pub. Date: Mar. 19, 2026

(54) MOTOR TRANSMISSION MECHANISM AND UPPER LIMB REHABILITATION ROBOT

(71) Applicant: Futronics (NA) Corporation, Pasadena, CA (US)

(72) Inventors: QIANSHAN LI, Pasadena, CA (US); Wenda Xu, Pasadena, CA (US); Fangyun Zhao, Pasadena, CA (US); Chengkun Zhang, Pasadena, CA (US); Huan Tan, Pasadena, CA (US)

(21) Appl. No.: 18/885,540

(22) Filed: Sep. 13, 2024

(51) Int. Cl. A61H 1/02

(52) U.S. Cl. CPC A61H 1/0274; A61H 2201/1207; A61H 2201/1454; A61H 2201/1635; A61H 2201/5058

(57) ABSTRACT

A motor transmission mechanism and an upper limb rehabilitation robot are provided. The motor transmission mechanism includes a motor, a torque sensor, an output component, a support bearing, and a mounting structure. The torque sensor, the output component, and an inner ring of the support bearing are sequentially fixedly connected along an axial direction of the motor. The mounting structure has an accommodation cavity and an opening structure in communication with the accommodation cavity. The torque sensor, at least a portion of the output component, and the support bearing are disposed within the accommodation cavity. The output component passes through the opening structure to an outside of the mounting structure, and the motor and an outer ring of the support bearing are fixed to the mounting structure.

### BACKGROUND

### 1. Technical Field

The present disclosure relates to the technical field of medical instruments, particularly to a motor transmission mechanism and an upper limb rehabilitation robot.

### 2. Description of Related Art

After a stroke or other illnesses, patients may experience limited mobility in their limbs. To help patients gradually recover, rehabilitation robots can be used to assist in the movement of their limbs. For example, rehabilitation robots can provide traction to guide the movement of patients' limbs, and can also provide resistance that patients need to overcome in order to enhance muscle exercise for the patients.

An upper limb rehabilitation assistive robot primarily assists patients in rehabilitation training for their upper limbs. The arms are placed on arm supports, and the positions of the arm supports are adjusted by a motor transmission mechanism. The motor transmission mechanism transmits power through the motor, and can output rotary motion, oscillating motion, linear motion, etc., by combining the motor with transmission structures such as gears and timing belts. When the motor transmission mechanism outputs rotary or oscillating motions, the motor needs to withstand a certain amount of torque. However, the current motor transmission mechanisms can withstand relatively small torques, the torques are unable to be detected, and the current motor transmission mechanisms have relatively large volumes.

### BRIEF DESCRIPTION OF THE DRAWINGS

In order to more clearly illustrate the technical solutions in this embodiment disclosure, the drawings used in the embodiments or the description of the prior art will be briefly introduced below. It should be understood that, the drawings in the following description are only examples of the present disclosure. For those skilled in the art, other drawings can be obtained based on these drawings without creative works.

FIG. 1 is a perspective diagram of a motor transmission mechanism according to an embodiment of the present disclosure.

FIG. 2 is a sectional diagram of a motor transmission mechanism according to an embodiment of the present disclosure.

FIG. 3 is partially enlarged view of location A in FIG. 2.

FIG. 4 is a perspective diagram of a first sensor adapter according to an embodiment of the present disclosure.

FIG. 5 is a sectional diagram of a second sensor adapter according to an embodiment of the present disclosure.

FIG. 6 is a perspective diagram of a motor according to an embodiment of the present disclosure.

FIG. 7 is a perspective diagram of an output component according to an embodiment of the present disclosure.

FIG. 8 is an exploded diagram of a mounting structure according to an embodiment of the present disclosure.

FIG. 9 is a perspective diagram of an upper limb rehabilitation robot according to an embodiment of the present disclosure.

### REFERENCE NUMERALS IN THE DRAWINGS

1000—upper limb rehabilitation robot;
100—motor transmission mechanism; 10—motor; 11—output flat shaft; 12—third connection hole; 13—ninth connection hole; 14—output shaft; 20—sensor adapter; 21—third annular mounting portion; 211—second connection hole; 22—positioning portion; 23—first annular mounting portion; 24—second annular mounting portion; 25—transition portion; 26—stopper plate; 27—first fixing element; 28—positioning groove; 30—torque sensor; 40—output component; 41—first output portion; 411—fourth connection hole; 412—positioning boss; 413—sixth connection hole; 42—second output portion; 50—support bearing; 60—mounting structure; 601—accommodation cavity; 61—first mounting piece; 611—eighth connection hole; 62—second mounting piece; 621—accommodation groove; 63—opening structure; 72—second fixing element; 73—third fixing element; 74—fourth fixing element; 75—fifth fixing element; 76—sixth fixing element; 77—seventh fixing element; 200—arm bracket.

### DETAILED DESCRIPTION

In order to facilitate the understanding of the present application, the present application will be described more comprehensively with reference to the relevant drawings. Preferred embodiments of the present application are shown in the drawings. However, the present application can be implemented in many different forms and is not limited to the embodiments described herein. On the contrary, the purpose of providing these embodiments is to make the disclosure of the present application more thorough and comprehensive.

It should be noted that when an element is referred to as being “fixed to” another element, it can be directly on another element or an intermediate element may also be present. When an element is considered to be “connected to” another element, it can be directly connected to another element or an intermediate element may be present at the same time.

Terms “length,” “width,” “upper,” “lower,” “front,” “rear,” “left,” “right,” “vertical,” “horizontal,” “perpendicular,” “top,” “bottom,” “inner,” “outer,” and other directional or positional relationships are based on the orientation or positional relationships shown in the accompanying drawings. They are used for the purpose of facilitating the description and simplifying the explanation in this application, and should not be interpreted as indicating or implying that the device or component referred to must have specific orientations, be constructed or operated in specific orientations. Therefore, they should not be understood as limiting the scope of this application.

Furthermore, the terms “first” and “second” are used for descriptive purposes only and should not be interpreted as indicating or implying relative importance or the quantity of technical features being referred to. Thus, features designated as “first” or “second” may include one or more of those features, either explicitly or implicitly. In the description of this application, the terms “multiple” and “several” mean two or more, unless otherwise specifically stated.

It should be noted that the structures, proportions, sizes, etc., depicted in the drawings of this specification are intended to complement the disclosed content and facilitate the understanding and reading of those skilled in the art, and are not intended to limit the conditions under which this application can be implemented. Therefore, any modifications to the structure, changes in proportion, or adjustments in size that do not affect the efficacy or objectives of this application are still within the scope of the disclosed technical content of this application.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. As used herein, the term “and/or” includes any and all combinations of one or more of the associated listed items.

A motor transmission mechanism transmits power through a motor, and can output rotary motion, oscillating motion, linear motion, etc., by combining the motor with transmission structures such as gears and timing belts. When the motor transmission mechanism outputs rotary or oscillating motions, the motor needs to withstand a certain amount of torque. Current motor transmission mechanisms can withstand relatively small torques, the torques are unable to be detected, and the current motor transmission mechanisms have relatively large volumes.

To alleviate the aforementioned technical issues, the present disclosure provides a motor transmission mechanism 100, including a motor 10, a torque sensor 30, an output component 40, a support bearing 50, and a mounting structure 60. The motor 10 drives the output component 40 to rotate, an output torque of the motor 10 can be detected by the torque sensor 30, which in turn allows for more precise control of the motor 10. One end of the output component 40 is connected to the torque sensor 30, and the other end thereof is supported by the support bearing 50. The support bearing 50 is mounted on the mounting structure 60. Supporting the output component 40 by the support bearing 50 can increase the torque that the output component 40 can withstand, and also makes the rotation of the output component 40 smoother. Additionally, the torque sensor 30, at least a portion of the output component 40, and the support bearing 50 are disposed within an accommodation cavity 601 of the mounting structure 60, which can contribute to a more compact structure and a smaller volume of the motor transmission mechanism 100.

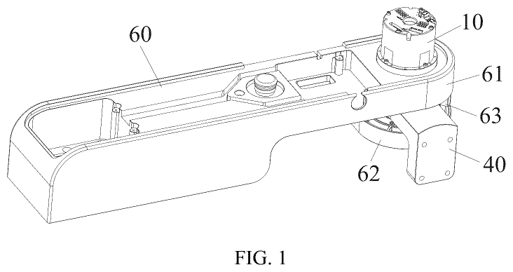

Referring to FIGS. 1 to 9, the motor transmission mechanism 100 and an upper limb rehabilitation robot 1000 provided in embodiments of the present disclosure are described.

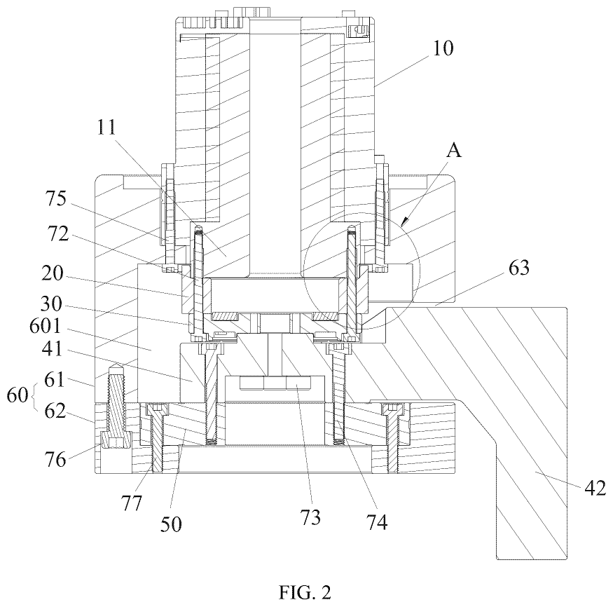

Referring to FIGS. 1 and 2 together, the motor transmission mechanism 100 includes a motor 10, a torque sensor 30, an output component 40, a support bearing 50, and a mounting structure 60. The motor 10, the torque sensor 30, and the output component 40 are sequentially connected in a transmission way, and the torque sensor 30, the output component 40, and an inner ring of the support bearing 50 are sequentially fixedly connected along an axial direction of the motor 10. For convenience of illustration, the axial direction of the motor 10 and a direction parallel to the axial direction are referred to as the “axial direction”, and a radial direction of the motor 10 and a direction parallel to the radial direction are referred to as the “radial direction”.

The motor 10 is a power component of the motor transmission mechanism 100. The motor 10 has a power output end capable of outputting rotary motion, and the power output end of the motor 10 is fixedly connected to the torque sensor 30, so that the power of the motor 10 can be transmitted to the torque sensor 30.

The torque sensor 30 is used to detect the output torque of the motor 10, and a user can directly read the output torque, facilitating precise control of the motor 10. The torque sensor 30 is used to connect the power output end of the motor 10 to the output component 40, so that the power of the motor 10 is transmitted to the output component 40.

The output component 40 is an end component of the motor transmission mechanism 100, and the output component 40 can be connected to an end actuator to achieve oscillating motion, rotary motion, and the like. Since the power output end of the motor 10, the torque sensor 30, and the output component 40 are connected sequentially, the output component 40 rotates synchronously with the power output end of the motor 10, featuring a short transmission chain and no transmission clearance, which results in smoother rotation of the output component 40.

The support bearing 50 is used to support the output component 40. Specifically, one axial end of the output component 40 is connected to the torque sensor 30 and supported by the torque sensor 30, and the other axial end of the output component 40 is connected to the inner ring of the support bearing 50 and supported by the support bearing 50. In this way, both axial ends of the output component 40 are supported, which can increase the load that the output component 40 can withstand. The support bearing 50 includes an inner ring and an outer ring. The inner ring is able to rotate relative to the outer ring. The inner ring of the support bearing 50 is fixedly connected to the output component 40, and the outer ring of the support bearing 50 is fixedly connected to the mounting structure 60, so that the support bearing 50 is mounted to the mounting structure 60, and is able to better support the output component 40.

The mounting structure 60 is the main support structure for the motor transmission mechanism 100, and the motor 10 and the support bearing 50 are mounted to the mounting structure 60. Specifically, a fixed end (e.g., a housing structure) of the motor 10 is fixed to the mounting structure 60, and the outer ring of the support bearing 50 is fixed to the mounting structure 60. The mounting structure 60 has an accommodation cavity 601 and an opening structure 63 in communication with the accommodation cavity 601. The torque sensor 30, at least a portion of the output component 40, and the support bearing 50 are disposed within the accommodation cavity 601. A portion of the output component 40 is disposed within the accommodation cavity 601 and is connected to the torque sensor 30, and another portion of the output component 40 passes through the opening structure 63 to the outside of the accommodation cavity 601. The structure that is of the output component 40 and is located outside the accommodation cavity 601 may be connected to other actuators to achieve different functions in different products.

When the motor transmission mechanism 100 is in operation, the motor 10 outputs a rotary motion, and the torque sensor 30, the output component 40, and the inner ring of the support bearing 50 rotate synchronously. The torque sensor 30 can detect the output torque of the motor 10 in real time.

The motor transmission mechanism 100 in the aforementioned embodiment includes the motor 10, the torque sensor 30, the output component 40, the support bearing 50, and the mounting structure 60, the torque sensor 30 can detect the output torque of the motor 10, facilitating more precise control of the motor 10. The motor 10 and the outer ring of the support bearing 50 are fixed to the mounting structure 60. The mounting structure 60 has an accommodation cavity 601, and the torque sensor 30, at least a portion of the output component 40, and the support bearing 50 are disposed in the accommodation cavity 601, so as to make the structure of the motor transmission mechanism 100 more compact and to reduce the volume. Supporting the output component 40 by the support bearing 50 can increase the torque that the output component 40 can withstand, and also makes the load-bearing capacity stronger.

In some embodiments of the present disclosure, referring to FIGS. 2 to 5, the motor 10 and the torque sensor 30 are fixedly connected by the sensor adapter 20. One axial end of the sensor adapter 20 is fixedly connected to the power output end of the motor 10, and the other axial end of the sensor adapter 20 is fixedly connected to the torque sensor 30.

The motor 10 and the torque sensor 30 may not be directly mounted due to various reasons such as structural differences, dimensional differences, specification differences, mounting spacing limitations, and so on between the motor 10 and the torque sensor 30, and may need to be transitionally connected by using the sensor adapter 20. Therefore, an indirect connection between the motor 10 and the torque sensor 30 can be achieved by arranging the sensor adapter 20.

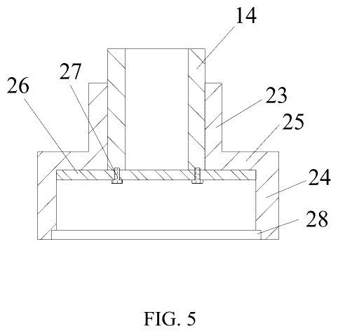

In some embodiments of the present disclosure, referring to FIG. 5, the motor 10 has an output shaft 14, that is to say, the motor 10 has a protruding rear output shaft. In this embodiment, the power output end of the motor 10 is the output shaft 14.

In some embodiments, referring to FIG. 5, the sensor adapter 20 includes a first annular mounting portion 23, a second annular mounting portion 24, and a transition portion 25 connecting the first annular mounting portion 23 and second annular mounting portion 24. The first annular mounting portion 23 is sleeved on an outer periphery of the output shaft 14, and the second annular mounting portion 24 is fixedly connected to the torque sensor 30. The first annular mounting portion 23 is used for fixedly connecting to the output shaft 14, and the second annular mounting portion 24 is used for fixedly connecting to the torque sensor 30. The fixed connection between the torque sensor 30 and the output shaft 14 is achieved by using the sensor adapter 20.

The sensor adapter 20 has a first annular mounting portion 23 that is sleeved on the outer periphery of the output shaft 14, adapted for connecting to the output shaft 14. The sensor adapter 20 also has a second annular mounting portion 24, adapted for connecting to the torque sensor 30. In this way, the indirect connection between the motor 10 and the torque sensor 30 is achieved by using the sensor adapter 20.

Optionally, the first annular mounting portion 23 is tightly connected to the output shaft 14, that is to say, the first annular mounting portion 23 and the output shaft 14 are interference-fit, to achieve mutual fixation of the two. An inner diameter of the first annular mounting portion 23 and an outer diameter of the output shaft 14 are in a state of interference fit. Under the action of an external force, the first annular mounting portion 23 is sleeved on the output shaft 14 and is not easy to fall off from the output shaft 14. There is no need to use other tight-fitting connectors after mounting.

Optionally, the motor transmission mechanism 100 further includes a stopper plate 26 and a first fixing element 27. The stopper plate 26 is disposed at an end of the output shaft 14 and is capable of stopping the first annular mounting portion 23. The first fixing element 27 passes through the stopper plate 26 and is connected to the end of the output shaft 14 (the end provided with the stopper plate 26). The stopper plate 26 and the first fixing element 27 can achieve an axial limiting between the output shaft 14 and the first annular mounting portion 23. The first annular mounting portion 23 is sleeved on the output shaft 14, and one end of the first annular mounting portion 23 is flush with one end of the output shaft 14. The stopper plate 26 is fixed to one end of the output shaft 14 by the first fixing element 27, and a dimension of an outer edge of the stopper plate 26 is greater than a diameter of the output shaft 14, enabling the stopper plate 26 to stop the end of the first annular mounting portion 23. The stopper plate 26 is provided with a through hole, and the output shaft 14 is provided with a threaded hole at an end thereof, and the first fixing element 27 passes through the through hole of the stopper plate 26 and is connected to the threaded hole of the output shaft 14, thereby pressing the stopper plate 26 on the output shaft 14 and the first annular mounting portion 23, and achieving the axial limiting of the output shaft 14 and the first annular mounting portion 23.

Optionally, the first annular mounting portion 23 is tightly connected to the output shaft 14. In addition, the motor transmission mechanism 100 further includes a stopper plate 26 and a first fixing element 27, the stopper plate 26 is disposed at one end of the output shaft 14 and is capable of stopping the first annular mounting portion 23. The first fixing element 27 passes through the stopper plate 26 and is connected to one end of the output shaft 14. In this way, the interconnection of the first annular mounting portion 23 and the output shaft 14 can be more stable, and the first annular mounting portion 23 can move in the axial direction relative to the output shaft 14.

Optionally, the second annular mounting portion 24 and the torque sensor 30 are fixedly connected by a fixing element such as a screw. Specifically, both the second annular mounting portion 24 and the torque sensor 30 have connection holes, and the fixing element passes through the connection hole on the torque sensor 30 and is connected to the connection hole on the second annular mounting portion 24, so that the second annular mounting portion 24 and the torque sensor 30 can be fixedly connected.

Optionally, an end of the first annular mounting portion 23 away from the transition portion 25 is provided with a positioning groove 28, and the torque sensor 30 is disposed in the positioning groove 28. The end of the first annular mounting portion 23 away from the transition portion 25 is a side of the first annular mounting portion 23 facing the torque sensor 30. At least a portion of the torque sensor 30 is located in the positioning groove 28, an inner peripheral wall of the positioning groove 28 matches with an outer peripheral wall of the torsion sensor, and a bottom wall of the positioning groove 28 and an end of the torsion sensor abut against each other, thereby achieving a radial positioning of the torsion sensor and the first annular mounting portion 23.

Optionally, the first annular mounting portion 23 and the second annular mounting portion 24 are both cylindrical with open ends at both sides. An inner diameter of the first annular mounting portion 23 is less than an inner diameter of the second annular mounting portion 24. The transition portion 25 is circular, and the transition portion 25 may be understood to extend radially from an outer periphery of the first annular mounting portion 23 towards the second annular mounting portion 24 to connect the first annular mounting portion 23 and the second annular mounting portion 24. Since the inner diameter of the first annular mounting portion 23 and the inner diameter of the second annular mounting portion 24 are different, a step shape is formed at the transition portion 25 to match both the output shaft 14 and the torque sensor 30.

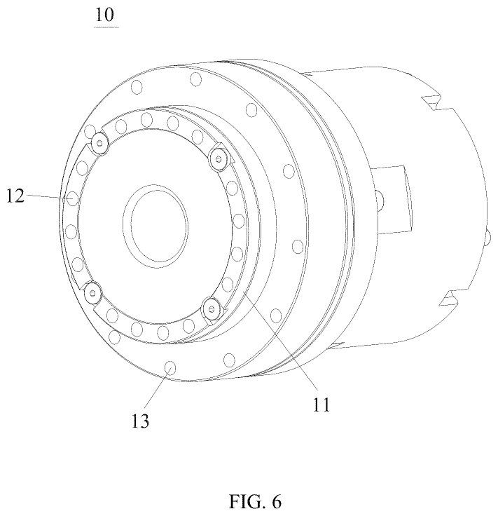

In some embodiments of the present disclosure, referring to FIG. 6, the motor 10 has an output flat shaft 11. The output flat shaft 11 has a smaller protruding height and a larger diameter relative to the output shaft 14. In this embodiment, the power output end of the motor 10 is the output flat shaft 11.

In some embodiments, referring to FIGS. 2 to 4, the sensor adapter 20 includes a third annular mounting portion 21 and a positioning portion 22 extending axially from the third annular mounting portion 21. The second fixing element 72 passes through the torque sensor 30 and the third annular mounting portion 21, and is connected to the output flat shaft 11. The positioning portion 22 has a radial positioning fit with the output flat shaft 11.

The third annular mounting portion 21 is connected to both the torque sensor 30 and the output flat shaft 11. Specifically, the third annular mounting portion 21 is provided with connection holes extending along an axial direction thereof. The connection holes run through axial two ends of the third annular mounting portion 21. The torque sensor 30 and the output flat shaft 11 are provided with connection holes. The second fixing element 72 passes through the connection holes of the torque sensor 30 and the connection holes of the third annular mounting portion 21, and is connected to the connection holes of the output flat shaft 11, so that the torque sensor 30, the sensor adapter 20, and the output flat shaft 11 are fixedly connected. The connection holes on the torque sensor 30, the connection holes on the sensor adapter 20, and the connection holes on the output flat shaft 11 are mutually aligned.

The positioning portion 22 is formed by an outer edge of the third annular mounting portion 21 extending in the axial direction, and an inner peripheral wall of the positioning portion 22 matches with an outer peripheral wall of the output flat shaft 11. When the sensor adapter 20 is mounted on the output flat shaft 11, an end portion of the output flat shaft 11 extends into an area enclosed by the positioning portion 22, the inner peripheral wall of the positioning portion 22 and the outer peripheral wall of the output flat shaft 11 form a radial positioning, and an end surface of the third annular mounting portion 21 and an end surface of the output flat shaft 11 abut against each other.

When the connection holes on the torque sensor 30 match with the connection holes on the output flat shaft 11, the relative position between the torque sensor 30 and the output flat shaft 11 can be adjusted by providing the sensor adapter 20, and a positioning portion 22 can also be provided on the sensor adapter 20 to achieve a radial positioning fit between the sensor adapter 20 and the output flat shaft 11, which is convenient for the assembly of the sensor adapter 20 and the output flat shaft 11.

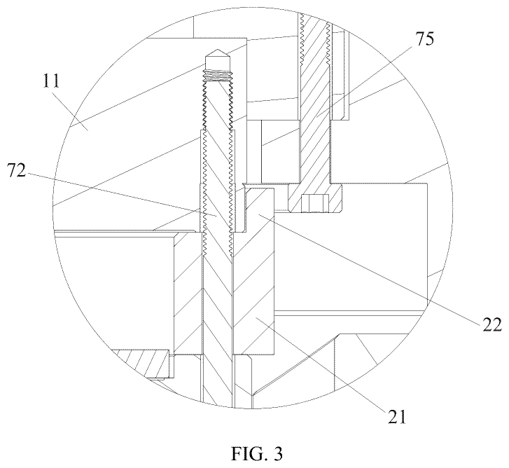

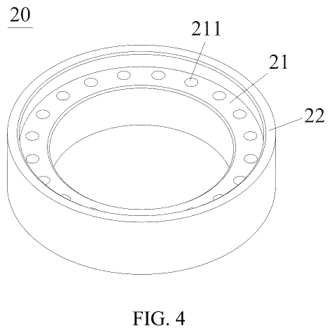

In some embodiments, referring to FIGS. 3 and 4, the connection holes provided on the torque sensor 30 are first connection holes, the connection holes provided on the third annular mounting portion 21 are second connection holes 211, and the connection holes provided on the output flat shaft 11 are third connection holes 12. A plurality of the first connection holes, the second connection holes 211, and the third connection holes 12 are provided. The plurality of first connection holes, the plurality of second connection holes 211, and the plurality of third connection holes 12 are arranged in an annular shape, so that the connection of the torque sensor 30, the sensor adapter 20, and the output flat shaft 11 is more stable.

In some embodiments, referring to FIG. 6, the output flat shaft 11 is provided in a protruding manner, such that the output flat shaft 11 extends into the area enclosed by the positioning portion 22.

In some embodiments of the present disclosure, referring to FIGS. 1, 2, and 7, the output component 40 includes a first output portion 41 located within the accommodation cavity 601 and a second output portion 42 located outside the accommodation cavity 601. The first output portion 41 has a positioning boss 412 for radial positioning fit with the torque sensor 30, and both the torque sensor 30 and an inner ring of the support bearing 50 are fixedly connected to the first output portion 41. The first output portion 41 located in the accommodation cavity 601 is connected to the torque sensor 30 and is driven to rotate by the torque sensor 30. The second output portion 42 is located outside the accommodation cavity 601 and can be connected to an external actuator or the like, to achieving the rotary or oscillating motion of the external actuator. The first output portion 41 has a positioning boss 412, and the positioning boss 412 has a radial positioning fit with the torque sensor 30. The radial positioning fit means that the positioning boss 412 and the torque sensor 30 are fixed to each other in the radial direction.

The first output portion 41 of the output component 40 is fixedly connected to both the torque sensor 30 and the inner ring of the support bearing 50. The first output portion 41 has a positioning boss 412, which enables a radial positioning fit with the torque sensor 30, so that the assembly of the first output portion 41 and the torque sensor 30 is easier.

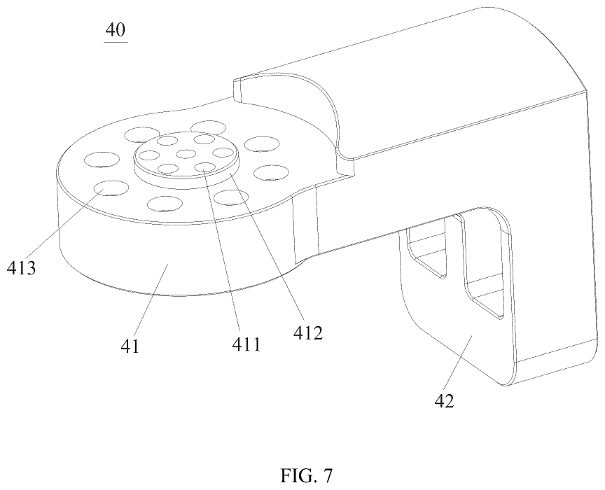

In some embodiments, referring to FIGS. 2 and 7, the first output portion 41 is provided with a fourth connection hole 411, and the torque sensor 30 is provided with a fifth connection hole. When the first output portion 41 and the torque sensor 30 are aligned, the fourth connection hole 411 and the fifth connection hole are aligned, and the third fixing element 73 passes through the fourth connection hole 411 and is connected to the fifth connection hole, so that the first output portion 41 and the torque sensor 30 are fixed to each other.

Optionally, there are a plurality of the fourth connection holes 411 and a plurality of the fifth connection holes, which can make the connection between the first output portion 41 and the torque sensor 30 more stable. The plurality of fourth connection holes 411 and the plurality of fifth connection holes may be arranged in an annular shape.

In some embodiments, referring to FIGS. 2 and 7, the first output portion 41 is provided with a sixth connection hole 413, and the inner ring of the support bearing 50 is provided with a seventh connection hole. When the first output portion 41 and the inner ring of the support bearing 50 are aligned, the sixth connection hole 413 and the seventh connection hole are aligned, and the fourth fixing element 74 passes through the sixth connection hole 413 and is connected to the seventh connection hole, so that the first output portion 41 and the inner ring of the support bearing 50 are fixed to each other.

Optionally, there are a plurality of the sixth connection holes 413 and a plurality of the seventh connection holes, which can make the connection between the first output portion 41 and the inner ring of the support bearing 50 more stable. The plurality of sixth connection holes 413 and the plurality of seventh connection holes may be arranged in an annular shape.

In some embodiments, the fourth connection hole 411 is disposed close to the center of the first output portion 41, and the sixth connection hole 413 is disposed close to the edge of the first output portion 41. In this way, the fourth connection hole 411 and the sixth connection hole 413 can avoid each other, facilitating mounting.

In some embodiments, the fourth connection hole 411 is provided on the positioning boss 412, which is located at the center of the first output portion 41, facilitating the assembly and connection of the first output portion 41 and the torque sensor 30.

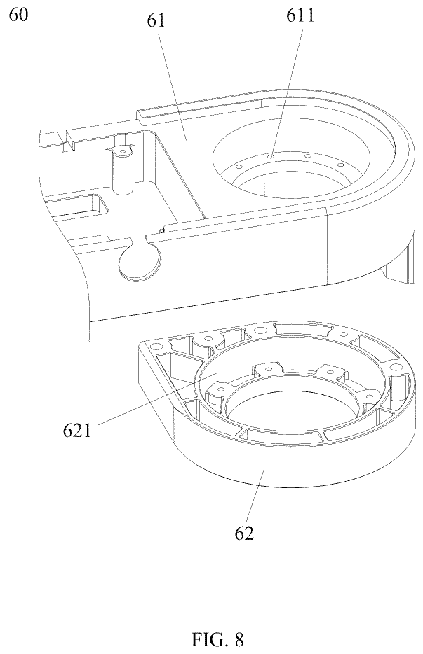

In some embodiments of the present disclosure, referring to FIGS. 1 and 8, the mounting structure 60 includes a first mounting piece 61 and a second mounting piece 62. The first mounting piece 61 is provided with an open end, and the second mounting piece 62 is covered on the open end. The opening structure 63 is disposed on the first mounting piece 61. The motor 10 is fixed to a side of the first mounting piece 61 away from the second mounting piece 62. The outer ring of the support bearing 50 is fixed to the second mounting piece 62. The first mounting piece 61 and the second mounting piece 62 are provided separately. The interior of the first mounting piece 61 is formed with an accommodation cavity 601 as described above, and the first mounting piece 61 is provided with an open end, so that the accommodation cavity 601 is also provided with an opening. The second mounting piece 62 shields the open end, reducing the open area of the mounting structure 60. The motor 10 and the support bearing 50 are fixed to opposite sides of the mounting structure 60, respectively. Specifically, the motor 10 is fixed to the side of the first mounting piece 61 away from the second mounting piece 62, and the outer ring of the support bearing 50 is fixed to a side that is of the second mounting piece 62 and is facing the accommodation cavity 601.

The mounting structure 60 includes a first mounting piece 61 and a second mounting piece 62 that are disposed separately, so that the torque sensor 30, the output component 40, and the like can be more easily mounted inside the accommodation cavity 601, and so that the opening structure 63 can be more easily formed. An edge notch is disposed on the side of the first mounting piece 61 facing the second mounting piece 62, i.e., the above-described opening structure 63 is formed.

During mounting the motor transmission mechanism 100, the motor 10 is first mounted to the first mounting piece 61, and then the sensor adapter 20 and the torque sensor 30 are placed in a pre-mounting position, and the power output end of the motor 10, the sensor adapter 20, and the torque sensor 30 are fixed to each other by the fixing element. Then, the support bearing 50 is fixed to the second mounting piece 62, and the output component 40 is fixed to the inner ring of the support bearing 50. Finally, the second mounting piece 62 is fixedly connected to the first mounting piece 61, and the output component 40 is fixedly connected to the torque sensor 30.

In some embodiments, referring to FIGS. 2 and 6, an eighth connection hole 611 is provided on a side of the first mounting piece 61, a ninth connection hole 13 is provided on a fixed end (e.g., a housing) of the motor 10. The fifth fixing element 75 passes through the eighth connection hole 611 and is connected to the ninth connection hole 13, thereby fixing the motor 10 to the first mounting piece 61.

Optionally, there are a plurality of the eighth connection holes 611 and a plurality of the ninth connection holes 13. The plurality of eighth connection holes 611 and the plurality of ninth connection holes 13 may be arranged in an annular shape.

In some embodiments, referring to FIGS. 2 and 8, the first mounting piece 61 and the second mounting piece 62 are connected to each other by a sixth fixing element 76. Both the first mounting piece 61 and the second mounting piece 62 are provided with connection holes, and the sixth fixing element 76 passes through the connection hole on the second mounting piece 62 and is connected to the connection hole on the first mounting piece 61, so as to achieve mutual fixation of the first mounting piece 61 and the second mounting piece 62.

Optionally, there are a plurality of the sixth fixing elements 76, and the plurality of sixth fixing elements 76 may be arranged in an annular shape.

In some embodiments, referring to FIGS. 2 and 8, the outer ring of the support bearing 50 and the second mounting piece 62 are connected by a seventh fixing element 77. The outer ring of the support bearing 50 and the second mounting piece 62 are provided with connection holes, and the seventh fixing element 77 passes through the connection hole on the support bearing 50 and is connected to the connection hole on the second mounting piece 62, so as to achieve mutual fixation of the second mounting piece 62 and the outer ring of the support bearing 50.

Optionally, there are a plurality of the seventh fixing elements 77, and the plurality of seventh fixing elements 77 may be arranged in an annular shape.

In some embodiments, referring to FIG. 8, at least a portion of the first mounting piece 61 is in a shape of a cylinder, and the opening structure 63 is disposed at a peripheral side of the first mounting piece 61 to enable the output component 40 to protrude from the peripheral side of the mounting structure 60.

In some embodiments, referring to FIG. 8, the second mounting piece 62 is in a shape of a circular ring, allowing screwdrivers and other disassembly/assembly tools to pass through the second mounting piece 62 and extend into the accommodation cavity 601, so as to mount and fix the support bearing 50 and the torque sensor 30.

In some embodiments, referring to FIGS. 2 and 8, the second mounting piece 62 is provided with an accommodation groove 621 on a side thereof facing the accommodation cavity 601. The support bearing 50 is disposed in the accommodation groove 621, and a thickness of the support bearing 50 is less than or equal to a depth of the accommodation groove 621. The accommodation groove 621 is used to accommodate the support bearing 50, and an inner peripheral wall of the accommodation groove 621 matches with an outer peripheral wall of the support bearing 50, to achieve a radial limiting between the support bearing 50 and the second mounting piece 62. The thickness of the support bearing 50 is less than or equal to the depth of the accommodation groove 621, such that the support bearing 50 does not protrude from the second mounting piece 62.

By providing the accommodation groove 621 on the second mounting piece 62, the support bearing 50 is accommodated in the interior of the second mounting piece 62, and the support bearing 50 does not protrude out of the second mounting piece 62, avoiding mutual interference between the support bearing 50 and the first mounting piece 61 when the second mounting piece 62 is connected to the first mounting piece 61.

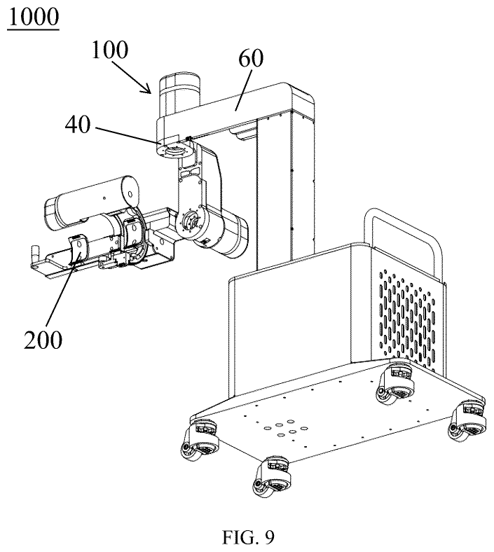

The present disclosure also provides an upper limb rehabilitation robot 1000, referring to FIG. 9, the upper limb rehabilitation robot 1000 includes a motor transmission mechanism 100 in any of the above embodiments. The upper limb rehabilitation robot 1000 is used for traction of the movement of patient's upper limb, or to provide resistance to the movement of the upper limbs, so as to train the patient's muscles. The upper limb rehabilitation robot 1000 also includes an arm bracket 200, and an arm can be placed on the arm bracket 200, and the motor transmission mechanism 100 drives the arm bracket 200 to move.

The upper limb rehabilitation robot 1000 provided by the present disclosure adopts the motor transmission mechanism 100 as described above. The motor transmission mechanism 100 includes a motor 10, a torque sensor 30, an output component 40, a support bearing 50, and a mounting structure 60. An output torque of the motor 10 can be detected by the torque sensor 30, facilitating more precise control of the motor 10. The motor 10 and the outer ring of the support bearing 50 are fixed to the mounting structure 60. The mounting structure 60 has an accommodation cavity 601, and the torque sensor 30, at least a portion of the output component 40, and the support bearing 50 are disposed in the accommodation cavity 601, so as to make the structure of the motor transmission mechanism 100 more compact and to reduce the volume. Supporting the output component 40 by the support bearing 50 can increase the torque that the output component 40 can withstand, and also makes the load-bearing capacity stronger.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A motor transmission mechanism, comprising a motor, a torque sensor, an output component, a support bearing, and a mounting structure;
wherein the motor, the torque sensor, and the output component are sequentially connected in a transmission way, the torque sensor, the output component, and an inner ring of the support bearing are sequentially fixedly connected along an axial direction of the motor;
wherein the mounting structure has an accommodation cavity and an opening structure in communication with the accommodation cavity, the torque sensor, at least a portion of the output component, and the support bearing are disposed within the accommodation cavity; the output component passes through the opening structure to an outside of the mounting structure, and the motor and an outer ring of the support bearing are fixed to the mounting structure.

2. The motor transmission mechanism according to claim 1, wherein the motor and the torque sensor are fixedly connected by a sensor adapter.

3. The motor transmission mechanism according to claim 2, wherein the motor has an output shaft; the sensor adapter comprises a first annular mounting portion, a second annular mounting portion, and a transition portion connecting the first annular mounting portion and second annular mounting portion; the first annular mounting portion is sleeved on an outer periphery of the output shaft, and the second annular mounting portion is fixedly connected to the torque sensor.

4. The motor transmission mechanism according to claim 3, further comprising a stopper plate and a first fixing element, wherein the stopper plate is disposed at an end of the output shaft and is capable of stopping the first annular mounting portion, and the first fixing element passes through the stopper plate and is connected to the end of the output shaft.

5. The motor transmission mechanism according to claim 3, wherein the second annular mounting portion is provided with a positioning groove at an end thereof away from the transition portion, and the torque sensor is disposed in the positioning groove.

6. The motor transmission mechanism according to claim 2, wherein the motor has an output flat shaft; the sensor adapter comprises a third annular mounting portion and a positioning portion extending axially from the third annular mounting portion, the second fixing element passes through the torque sensor and the third annular mounting portion, and is connected to the output flat shaft; the positioning portion has a radial positioning fit with the output flat shaft.

7. The motor transmission mechanism according to claim 6, wherein the third annular mounting portion is connected to both the torque sensor and the output flat shaft.

8. The motor transmission mechanism according to claim 1, wherein the output component comprises a first output portion located within the accommodation cavity and a second output portion located outside the accommodation cavity, the first output portion has a positioning boss configured for radial positioning fit with the torque sensor, and the torque sensor and the inner ring of the support bearing are fixedly connected to the first output portion.

9. The motor transmission mechanism according to claim 1, wherein the mounting structure comprises a first mounting piece and a second mounting piece; the first mounting piece is provided with an open end, and the second mounting piece is covered on the open end; the opening structure is disposed on the first mounting piece; the motor is fixed to a side of the first mounting piece away from the second mounting piece, and the outer ring of the support bearing is fixed to the second mounting piece.

10. The motor transmission mechanism according to claim 9, wherein the second mounting piece is provided with an accommodation groove on a side thereof facing the accommodation cavity 601, the support bearing is disposed in the accommodation groove, and a thickness of the support bearing is less than or equal to a depth of the accommodation groove.

11. An upper limb rehabilitation robot, comprising a motor transmission mechanism according to claim 1.

12. A motor transmission mechanism, comprising:
a motor, having a power output end;
an output component;
a torque sensor, configured to detect an output torque of the motor, wherein the torque sensor is fixedly connected to the power output end, and the torque sensor is configured for connecting the power output end to one end of the output component;
a support bearing, configured to support the other end of the output component; and
a mounting structure, the motor, at least a portion of the output component, the torque sensor, and the support bearing being disposed in the mounting structure;
wherein the motor, the torque sensor, and the output component are sequentially connected in a transmission way, the torque sensor, the output component, and the support bearing are sequentially fixedly connected along an axial direction of the motor.

13. The motor transmission mechanism according to claim 12, wherein the support bearing comprises an inner ring and an outer ring, the inner ring is capable of rotating relative to the outer ring; the inner ring is fixedly connected to the output component, and the outer ring is fixedly connected to the mounting structure, so that the support bearing is mounted to the mounting structure.

14. The motor transmission mechanism according to claim 12, wherein the mounting structure has an accommodation cavity and an opening structure in communication with the accommodation cavity;
wherein the torque sensor, at least a portion of the output component, and the support bearing are disposed within the accommodation cavity, a portion of the output component is disposed within the accommodation cavity and is connected to the torque sensor, and another portion of the output component passes through the opening structure to an outside of the accommodation cavity.

15. The motor transmission mechanism according to claim 12, further comprising a sensor adapter, one axial end of the sensor adapter is fixedly connected to the power output end, and the other axial end of the sensor adapter is fixedly connected to the torque sensor.

16. The motor transmission mechanism according to claim 15, wherein the sensor adapter comprises a first annular mounting portion, a second annular mounting portion, and a transition portion connecting the first annular mounting portion and second annular mounting portion; the first annular mounting portion is sleeved on an outer periphery of the power output end, and the second annular mounting portion is fixedly connected to the torque sensor.

17. The motor transmission mechanism according to claim 16, wherein the first annular mounting portion is tightly connected to the power output end.

18. The motor transmission mechanism according to claim 12, further comprising a stopper plate and a first fixing element, wherein the power output end is an output shaft, the stopper plate is disposed at an end of the output shaft and is capable of stopping the first annular mounting portion, and the first fixing element passes through the stopper plate and is connected to the end of the output shaft.

19. The motor transmission mechanism according to claim 18, wherein the stopper plate is provided with a through hole, and the output shaft is provided with a threaded hole at an end thereof;
wherein the first fixing element passes through the through hole of the stopper plate and is connected to the threaded hole of the output shaft, to press the stopper plate on the output shaft and the first annular mounting portion.

20. The motor transmission mechanism according to claim 16, wherein the first annular mounting portion and the second annular mounting portion are both cylindrical with open ends at both sides, an inner diameter of the first annular mounting portion is less than an inner diameter of the second annular mounting portion;
wherein the transition portion is circular, and the transition portion extends radially from an outer periphery of the first annular mounting portion towards the second annular mounting portion to connect the first annular mounting portion and the second annular mounting portion.
